(19) United States
(12) Patent Application Publication
(10) Pub. No.: US 2009/0147787 A1
(43) Pub. Date: Jun. 11, 2009

(54) METHOD AND APPARATUS FOR RTP EGRESS STREAMING USING COMPLEMENTARY DIRECTING FILE

(76) Inventors: Ambalavanar Arulambalam, Macungie, PA (US); Jian-Guo Chen, Basking Ridge, NJ (US); Nevin C, Heintze, Bethlehem, PA (US); Hakan I. Pekcan, Basking Ridge, NJ (US); Kent E. Wires, Mine Hill, NJ (US)

Correspondence Address: IP Legal Services, 1500 East Lancaster Avenue, Suite 200, P.O. Box 1027, Paoli, PA, 19301, US

(21) Appl. No.: 12/089,485

(22) PCT Filed: Oct. 6, 2006
(86) PCT No.: PCT/US2006/039224

§ 371 Date: Apr. 7, 2008

Related U.S. Application Data
(60) Provisional application No. 60/724,462, filed on Oct. 7, 2005.
(60) Provisional application No. 60/724,463, filed on Oct. 7, 2005.
(60) Provisional application No. 60/724,464, filed on Oct. 7, 2005.
(60) Provisional application No. 60/724,722, filed on Oct. 7, 2005.
(60) Provisional application No. 60/725,060, filed on Oct. 7, 2005.
(60) Provisional application No. 60/724,573, filed on Oct. 7, 2005.

(51) Int. Cl. H04L 12/56

(52) U.S. Cl. 370/392; 370/389

(57) ABSTRACT

A hardware accelerated streaming arrangement, especially for RTP real time protocol streaming, employs a directing file determining the pointers, header lengths and offsets of a block of one or more data packets to be sent out through a network accelerated streaming system. The directing file is established by a control processor, for example working in the background, and is stored to provide information making it possible to determine certain information including header sizes and pointers to RTP payload and other data, without the need during egress of the data for analysis related to the type of media or protocol concerned. This relieves the control processor of functions that would otherwise require attention, and permits the egress process to proceed in a repetitive manner, preferably relying insofar as possible on hardware elements for speed and reserving the control processors computational capacity for control functions that may be more complex but are infrequent and/or not time sensitive for streaming in real time.

### CROSS REFERENCE TO RELATED APPLICATIONS

This application claims the priority of U.S. provisional patent application Nos. 60/724,462, filed Oct. 7, 2005, 60/724,463, filed Oct. 7, 2005, 60/724,464, filed Oct. 7, 2005, 60/724,722, filed Oct. 7, 2005, 60/725,060, filed Oct. 7, 2005, and 60/724,573, filed Oct. 7, 2005, which applications are incorporated by reference herein in their entireties.

### BACKGROUND OF THE INVENTION

The invention concerns real time data transport apparatus and methods, for example in a digital video processing center or an entertainment system, conferencing system or other application using RTP streaming. The invention also is applicable to packet data transport applications wherein information is determined during packet handling and is inserted into outgoing data packet headers, for example as packet addressing or processing information. This operation needs to keep pace with a real time data rate for RTP streaming, preferably with limited computational load. According to the invention a directing file is composed by the controlling processor and facilitates insertion of such information during egress of the packets.

The inventive apparatus and methods serve various recording, playback and processing functions wherein content and control information is directed to and from functional elements that store, present or process data. In a data streaming context, certain steps are required when responding to control information. For example when initiating a connection, it is necessary to set up data packet processing and addressing arrangements to respond to the control information. It may be necessary to find or access the packets to be transported from a storage medium or a communication path or socket. Based on the control input and also on information found in the packets, the transport apparatus determines how exactly the transport will proceed. Required codes, flags, addresses and other conditional indicators may need to be determined and used in signaling, for example by insertion into packet headers or by providing new headers for blocks of data in which the original packets are to be carried, etc. These steps may require a good deal of computational complexity and generally rely on software.

After such a connection has been made and the data transport has commenced, the requirements are somewhat different. For example, the information, controls and addressing of a next packet in a continuing stream are likely to be closely related to the information used for the last previous packet. The successive packets may be intended for handling in much the same way through the stream. The packets may differ by incremental aspects, such as a packet sequence number. In the case of reading from storage of some kind, the source address will advance. However the level of computational complexity is less. These steps benefit from speed and efficiency and generally rely on hardware.

It is advantageous if repetitive data processing steps that not computationally complex, for example repetitive routing of data packets to and from network attached storage elements, are handled differently from functions, such as control processing and addressing steps, that are computationally complex but also are relatively infrequent. What is needed is an optimal solution.

It is advantageous in general to enable potentially different devices using potentially different data formats to interact. Design challenges are raised by the need to provide versatility in data processing systems, while accommodating different devices and data formats at high data rates.

Industry standards govern the formatting of certain data types. Standards affect addressing and signaling techniques, data storage and retrieval, communications, etc. Standards typically apply at multiple levels. For example, a packet signaling standard or protocol may apply when transporting video data that is encoded according to a video encoding standard, and so forth.

Packet data transported between a source and destination may advantageously be subjected to intermediate processing steps such as data format conversions, computations, buffering, and similar processing and/or storage steps. In a data processing system that has multiple servers and terminal devices, part of the computational load is directed to activities associated with data formatting and reformatting. Part of the load is addressing and switching between data sources and destinations, potentially changing arrangements in response to conditions such as user selections.

One requirement when streaming data packets is to provide in the outgoing data packets certain information that identifies the packets, for use by elements that are located further along the streaming signal path. It would be possible to employ a control processor to analyze streamed data on the fly, which would present a computational load. It might be possible to provide a hardware device to handle this function, but that device would need to be complex and would lack the versatility of programming. A different solution is needed.

The objects of streamlining and simplifying for speed, versus providing computational complexity, of course are inconsistent design objectives. It would be advantageous to optimize the concurrent need for speed and data capacity, versus the need for computational power, so as to provide arrangements that are both fast and versatile. The present invention subdivides certain functions needed for managing outgoing data packets, i.e., packet egress, so that the complex and adaptive computational functions of composing the necessary egress information are assigned to a control processor and can be substantially embodied by software.

In a preferred embodiment, the invention is demonstrated with respect to real time protocol (RTP) packet streaming. An exemplary group of packet source and destination types are discussed, applicable to video data processing for entertainment or teleconferencing, but potentially including security monitoring, gaming systems, and other uses. The transport paths may be wired or wireless, and may involve enterprise or public networks. The terminals for playback may comprise audio and video entertainment systems, computer workstations, fixed or portable devices. The data may be stored and processed using network servers. Exemplary communications systems include local and wide area networks, cable and telecommunications company networks, etc.

In connection with audio and video data, the Real Time Protocol (“RTP,” also known as the “Real Time Transport Protocol”) is a standard protocol that is apt for moving packetized audio and/or image and moving image data over data communication networks, at a real time data rate. Playback of audio and video data at a real time or live rate is desirable to minimize the need for storage buffers, while avoiding stopping and starting of the content. In applications such as teleconferencing and similar communications, the collection, processing, transport and readout of packetized data advantageously should occur with barely perceptible delays and no gaps, consistent with face-to-face real time conferences and conversations.

The RTP Real Time Protocol is a known protocol intended to facilitate handling of real-time data, including audio and video, in a streamlined way. It can be used for media-on-demand as well as interactive services such as Internet telephony. It can be used to direct audio and video to and from multiple sources and destinations, to enable presentation and/or recording together with concurrent processing.

The manner in which the data are handled is changeable from time to time, using control and addressing functions, for example to initiate and end connections involving particular sources, destinations or participants. Thus, RTP contains a data content part for transport of content, and a control part for varying the manner of data handling, including starting, stopping and addressing. The control part of RTP is called “RTCP” for Real Time Control Protocol.

The data part of RTP is a thin or streamlined protocol that provides support for applications with real-time properties such as the transport of continuous media (e.g., audio and video). This support includes timing reconstruction, loss detection or recovery, security, content identification and similar functions that are repetitive and occur substantially continuously with transport of the media content.

RTCP provides support for real-time conferencing of groups of any size within a communication network such as the Internet. This support includes source identification and support for gateways like audio and video bridges as well as multicast-to-unicast translators. It offers quality-of-service feedback from receivers to the multicast group as well as support for the synchronization of different media streams.

RTP and RTCP are data protocols that are particularly arranged to facilitate transport of data of the type discussed above, but in a given network configuration the RTP and RTCP protocols might be associated with higher or lower protocols and standards. On a higher level, for example, the RTP and RTCP protocols might be used to serve a video conferencing system or a view-and-store or other technique for dealing with data. On a lower or more basic level, the packets that are used in the RTP and RTCP data transport might actually be transmitted according to different packet transmission message protocols. Examples are Transmission Control Protocol (TCP or on the Internet, TCP/IP) and User Datagram Protocol (UDP).

The TCP and UDP protocols both are for packet transmission but they have substantially different characteristics regarding packet integrity and error checking, sensitivity to lost packets and other aspects. TCP generally uses aspects of the protocol to help ensure that a two way connection is maintained during a transmission and that the connection remains until all the associated packets are transmitted and assembled at the receiving end, possibly including re-tries to obtain packets that are missing or damaged. UDP generally handles packet transmission attempts, but it is up to the applications that send and receive the packets to ensure that all the necessary packets are sent and received. Some applications, such as streaming of teleconferencing images, are not highly sensitive to packets being intermittently dropped. But it is advantageous if packets should be dropped, that the streaming continue as seamlessly as possible.

It would be advantageous if techniques could be worked out wherein real time transmission is operable using a wide range of higher and lower protocols, while permitting the configuration to take full advantage of the ways in which the different protocols differ. It would be particularly useful in high performance or high demand systems to tailor the operation so that the resources available for communication and the resources available for computations and situation sensitive switching and decision making could be optimized.

### SUMMARY

It is an aspect of the invention to provide for efficient video and similarly continuous stream data processing, by employing data processing arrangements having distinct and contemporaneously operating transport data paths and control data paths, wherein the two data paths separately handle data-throughput intensive functions, and data-processing intensive functions, using distinct cooperating resources that separately are configured for throughput and processing power, respectively.

More particularly a method and apparatus are provided for facilitating and accelerating the processes conducted by a media server by partitioning subsets of certain resource-intensive processes associated with the real time protocol (RTP), for handling by processors and switching devices that are optimized for their assigned subsets. Partitioning of functions based on speed are assigned to devices that have the characteristics of data pipelines. The computational load is assigned to one or more central processors that govern the RTP sessions and handle the computational side with less processor attention paid to moving the streaming data in the data communication pipeline.

In certain embodiments, the method concerns using a hardware interface element that at least partly composes the information provided to define outgoing data blocks associated with RTP packet streaming. A directing file is provided in a manner that can be populated wholly or partly by the central processor, and is coupled to an accelerator element that accesses the directing file in connection with packet egress. The directing file guides the hardware accelerator in connection with packet egress. It is not necessary for the processor to analyze each packet, potentially handling different concurrent streaming connections. Instead, the processor sets up the directing file for each connection that is under way, and the accelerator applies the information as packets are sent out.

The accelerator can be a hardware interface element that operates at high data rates without substantial supervision, providing the necessary block and header information based on the contents of the directing file. The controlling processor is thereby freed for attention to functions that are computationally intensive. Although the accelerator is a hardware element in the preferred embodiments discussed, a processor in the accelerator is not precluded.

According to one embodiment, a content addressable memory (CAM) file is maintained by which a hardware accelerator associates multiple presently-maintained packet queues with certain addresses. The CAM file can be used to determine header information, especially in connection with data packets that contain multiple levels of offset headers. When a SETUP request is received to initiate a new streaming connection to a new endpoint, and no matching entry is found in the CAM file, the hardware accelerator signals the processor and an entry is established. The hardware accelerator is provided with associated header values, namely by initiating an entry in the content addressable memory (CAM) in anticipation of a RECORD or SEND message. The header values associated with the new endpoint are known to the control processor but the processor need only establish the routing to the new endpoint by setting up a new packet queue in the content addressable memory (CAM). The hardware accelerator can then operate as an automaton that finds the packet queue entries for an incoming packet, substitutes the necessary values, and passes the packet on toward its destination.

When an RTSP RECORD or SEND message is received that has an established queue entry, responsibility for determining the outgoing header values is on the hardware accelerator, in data communication with the traffic manager and the central processor. The connection can remain under way and with the benefit of a high data rate until completed or until the central processor effects necessary new controls and activities such as determining the endpoint or endpoints of the stream according to any of the programmable functions. Such functions can include many or all of the functions that otherwise would require a controller to decide via programmed software routines how to deal with each passing packet. Such functions can include routing of packets between sources and destinations, inserting intermediate processing steps, routing packets to two or more destinations at the same time, such as to record while playing, and so forth.

The present invention employs a directing file that contains information for a general header and a header block, that is established in addition to the RTP header and is used in connection with packet egress, i.e., output, so as to accelerate the management of packet output is a way that minimizes repetitive on-the-fly attention from the control processor.

Streaming data rate and throughput demands may be strict. In order keep pace using a processor, a very fast and capable central processor would be needed to discharge both computation loads and also the need to compose and insert information into outgoing data blocks. It is an inventive aspect to employ the directing file to minimize the computational loading on the central processor. Insofar as the directing file can be arranged to interface with a hardware accelerator, such computational loading may be limited substantially to setting up the directing file via the controller, and allowing the stream to continue to send data blocks, without controller supervision.

It is an aspect of the invention to provide an optimal solution to processing control and content packets in an efficient way. An RTSP/RTP solution should not be implemented either wholly in hardware or wholly in software, but is best implemented in a hybrid solution wherein the process is largely controlled by software, but the process generates register values and the like that can be employed, preferably using hardware, to accelerate data transfers using the media object and supporting files generated by software.

Due to their relative complexity and infrequency of operations, RTSP and RTCP (namely the packets used for the most part to manage control processes) can be implemented in on the central processor without overburdening it because RTSP or RTCP packets require infrequent attention. RTP processing, on the other hand, requires processing to attend to each outgoing packet in the media stream, and benefits from acceleration.

Packet egress streaming strictly requires support in real time, i.e., in pace with the real time rate of the data packets. The present invention employs a directing file, in an implementation that is in a sense using hinting and to provide the hardware with the RTP packet information that it needs, or to lead more directly to the generation of the necessary egress information. The control processor can be involved in determining the content of the directing file. However after the directing file is in place for a connection, the hinting technique accelerates RTP streaming on a server by removing the requirement that the server or controller analyze the media being streamed on-the-fly in order to proceed.

The inventive technique does not shift the responsibility wholly to the dedicated hardware. The technique, for example, does not require that the hardware have sufficient complexity as it might need to parse hint data.

The format for the directing file preferably is represented flexibly, to allow for future expansion. At the same time, the flexibility of the directing file format should not complicate the objective of offloading the repetitive and computationally simple aspects of streaming functionality to a hardware device.

The present method solves this problem by including necessary information, but not the media object itself, in a complementary file that can be used by the hardware. If a media file with a specified RTP packet type (namely a packet type defined according to an FRS) is accessible to the streamer, and it is a candidate for streaming, a directing file is generated. This file is generated by software running on the central processor, in the background, namely as a lower priority function that is handled when resources are available. The directing file is similar to hint data in that it tells the streamer how to packetize the object for RTP streaming. However, the inventive directing file is much more specific than hint data about how to effect egress of a packet. Thus, the inventive technique can operate where the central processor has even less knowledge about the native media object. These and other objects and aspects will become apparent in the following discussion of preferred embodiments and examples.

### BRIEF DESCRIPTION OF THE DRAWINGS

There are shown in the drawings certain exemplary and nonlimiting embodiments of the invention as presently preferred. Reference should be made to the appended claims, however, in order to determine the scope of the invention in which exclusive rights are claimed. In the drawings,

FIG. 1 is a block diagram illustrating a source-to-destination data transport relationship (e.g., server to client), according to the invention, wherein the RTP data content component is routed around a control point, such as a central processor that handles RTSP and/or RTCP control signaling.

FIG. 2 is a block diagram showing a streaming controller according to the invention.

FIG. 3 is a table showing the component values in an RTP header.

FIG. 4 is a data table diagram illustrating a directing file according to an exemplary embodiment.

FIG. 5 is a block diagram showing the components of a home network attached entertainment system “HNAS” that is advantageously configured to include the packet data handling provisions of the invention.

### DETAILED DESCRIPTION OF PREFERRED EMBODIMENTS

RTP does not address resource reservation and does not guarantee quality-of-service for real-time services, such as ensuring at the RTP protocol level that connections are maintained and packets are not lost, etc. The data transport protocol, namely RTP, is augmented by a control protocol (RTCP) that can be used for session control (namely RTP transfers from a source to a destination) and also an overall presentation control protocol (RTSP).

The RTCP and RTSP control protocols involve signaling packets that are transmitted, for example, when setting up or tearing down a transfer pathway, when initiating a transfer in one direction (PLAY) or the other direction (RECORD), when pausing and so forth. The content data packets need to stream insofar as possible continuously in real time with some synchronizing reference. The content packets are transmitted at the same time as the RTCP and RTSP packets but the packets of the three respective protocols use different addressed logical connections or sockets.

The RTCP/RTSP control and RTP data streaming protocols together provide tools that are scalable to large multicast networks. RTP and RTCP are designed to be independent of the underlying transport and network layers, and thus can be used with various alternative such layers. The protocol also supports the use of RTP-level translators and mixers, where desired.

The RTP control protocol (RTCP) has the capability to monitor the quality of service and to convey information about the participants in an on-going session. The participant information is sufficient for “loosely controlled” sessions, for example, where there is no explicit membership control and set-up, but a given application may have more demanding authorization or communication requirements, which is generally the ambit of the RTSP session control protocol.

RTP data content packets that are streamed between a source and destination are substantially simply passed along toward the destination address in real time. Whereas the packets are passing in real time, there is little need for buffering storage at the receiving apparatus. For the same reasons, the sending apparatus typically does not need to create temporary files. Unlike some other protocols, such as HTTP object transfer, RTP packetizes the object with media-specific headers. The RTP receiver is configured to recover from packet loss rather than having retry signaling capabilities. The RTP transfers can employ a TCP/IP connection-less protocol. Typically, RTP transfers are done with user datagram protocol (UDP) packet transfers of RTP data, typically but not necessarily with each UDP packet constituting one RTP packet.

An RTP packet has a fixed header identifying the packet as RTP, a packet sequence number, a timestamp, a synchronization source identification, a possibly empty list of contributing source identifiers, and payload data. The payload data contains a given count of data values, such as audio samples or compressed video data.

An RTP streaming system uses distinct real time data content packets (RTP), control packets (RTCP) and/or session control packets (RTSP). The management packets (RTCP, RTSP) relate to connections that can carry RTP content packets over one or more connections. The RTCP and RTSP connections involve different connection “sockets” that RTP, but more importantly, the packets are different in frequency and function.

It is possible to provide a processor in a receiver, such as a network connected entertainment system, a video conferencing system, a network attached storage device or the like, and to program the processor to discriminate appropriately between RTP packets and RTCP or RTSP control packets. The data packets are passed toward their destination and the control packets are used by the processor to effect other programmed functions and transfers of information. For such a system to keep pace, the RTP content packets must be handled in real time, and if the central processor is to manage particulars of the packets including fields inserted upon packet egress, the processor must operate at a high data rate.

The control packets in streaming situations can be directed to various scenarios of connections in one or more directions of data indifferent formats and involving plural endpoints. The control processor needs computational complexity and programming needed to handle potentially involved control processes. If a given processor capable of substantial computational complexity (e.g., having a complicated program) is also used simply for passing RTP content packets, then both a high data rate and complex computing capacity are needed. However the computing capacity to handle complex control computations, which are infrequent, is wasted if the processor spends most of its operational capacity on passing RTP packets one after another over one or a few readily distinguishable connections.

An aspect of the present invention is to provide a way in which the computational results developed by a control processor can be passed to a less complex but perhaps faster hardware device for passing the packets onward, i.e., for packet egress. This is accomplished using the directing file technique of the invention.

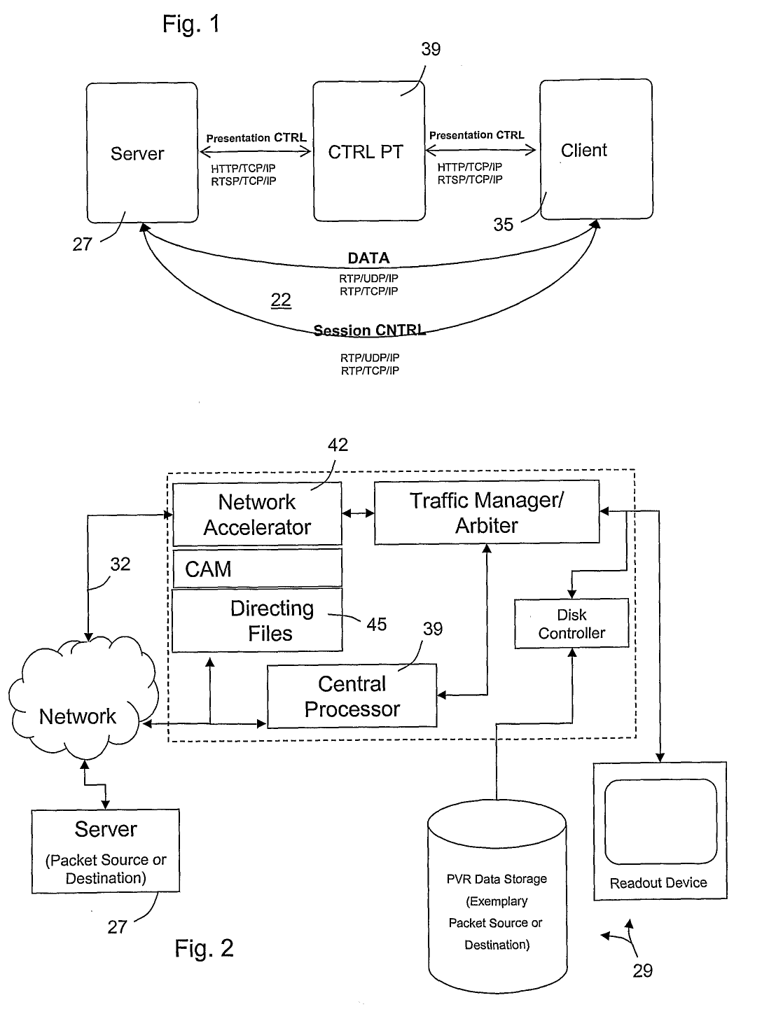

FIG. 1 shows a simple network environment with a control point disposed between a server (namely the source of the streaming data) and a client (the destination). Each interconnection is labeled with the various supported packet types for RTP streaming. The subject invention is broadly applicable to configurations involving a control point, and at least partly bypasses the need for processing at the control point, by providing a technique whereby fields in message headers are replaced using a hardware accelerator as described.

FIG. 2 shows an exemplary situation wherein the control point is represented by a central processor that is coupled to a packet source (shown as a server) over a network. In the configuration shown the central processor would conventionally be required to pass packets to one or more destinations, e.g., via a traffic manager/arbiter, by directing the packets identified in a stream of packets from the packet source to one or more addressable destinations, such as a network attached storage element, represented in this embodiment by disk memory and its controller, or to a readout device, etc.

According to an inventive aspect, the packet data is handled in part by an interface device in the form of network accelerator. The network accelerator can be embodied as a high throughput device with minimal if any computational sophistication, configured to insert values into data blocks comprising RTP packets so as to control their handling and further processing downstream. For this purpose, a directing file is produced and comprises a general header section containing an identifying code and a set of values including a packet count, header block size and pointers and/or length values that identify the position in the data of the RTP header to be processed.

The particular source and destination entities in this example are representative examples. The invention is applicable to situations involving a variety of potential sources and potential destinations that might be more or less proximal or distal and are coupled in data communication as shown, so as to function at a given time as the source or destination of packets passing in one or another or both directions between two such entities. This particular example might be arranged for the passage of packets in the situation where a content signal was to be shown on the playback device and recorded at the same time. In other examples, a data flow arrangement might be set up wherein data was recorded but not played back or played back but not recorded. Other particular source and destination elements could be involved. The same incoming packets could be routed from one source to two or more destinations. Alternatively, content from two or more sources could be designated for coordinated storage or playback, for example as a picture-in-picture inset or for simultaneous side by side display, for example when teleconferencing. These and other similar applications are readily possible according to the invention.

The data flows fall into three main types, namely RTSP packets for overall presentation control; RTCP packets for individual session control; and RTP packets for data content transfer.

RTSP is an application-layer protocol that is used to control one or many concurrent presentations or transfers of data. A single RTSP connection may control several RTP object transfers concurrently and/or consecutively. In a video conference arrangement, for example involving multiple locations, bidirectional transfers may be arranged between each pair of locations. The syntax of RTSP is similar to that of HTTP/1.1, but it provides conventions specific to media transfer. The major RTSP commands defining a session are:
SETUP: causes the server to allocate resources for a stream and start an RTSP session.
PLAY and RECORD: starts data transmission on a stream allocated via SETUP from a source to destination.
PAUSE: temporarily halts the stream without freeing server resources.
TEARDOWN: frees resources associated with the stream. The RTSP session ceases to exist on the server.

When the control point requests an object transfer using an RTSP SETUP request, it sends a request to the server and the client that includes the details of the object transfer, including the object identification, source and destination IP addresses and protocol ports, and the transport-level protocols (generally RTP, and either TCP or UDP) to be used. In this way, the RTSP requests describe the session to the client and server. In some cases the request can be specifically for a subset of an available object, such as an audio or video component of the object.

When all necessary SETUP requests have been made and acknowledged, the control point may issue a PLAY or RECORD request, depending on the direction of the transfer. The request may optionally designate a certain range of the object that is to be delivered, the normal play time of the object, and the local time at which the playback should begin.

Following the completion of playback, the presentation is automatically paused, as though a PAUSE command had been issued. When a PAUSE command is issued, it specifies the timestamp at which the stream should be paused, and the server (client) stops delivering data until a subsequent PLAY (RECORD) request is issued.

When a TEARDOWN request is issued, data delivery on the specified stream is halted, and all of the associated session resources are freed.

An RTSP command might specify an out-of-band transfer session wherein RTP/UDP or RTP/TCP is to be used for transport. An “out-of-band” transfer denotes two or more distinct transfer or connection paths. The RTSP traffic in that case can be over one connection, and a different connection can be specified by RTSP to carry the actual transport of RTP data.

RTP packets can be transported over TCP. This is generally inefficient because UDP transport does not require a maintained connection, is not sensitive to lost packets and/or does not try to detect and recover from lost packets, as does TCP. The UDP transport protocol is apt for transfer in real time of packets such as audio or video data sample values. Such values are not individually crucial but need to be moved in a high data volume. TCP is different from UDP in that connections are established, the protocol emphasizes reliability, e.g., seeking to recover from packet loss by obtaining retransmission, etc. These aspects are less consistent than UDP with the needs of RTP. This disclosure generally assumes that UDP will be used for RTP transmission. However the disclosure should not be considered as limited to the preferred UDP transport and instead encompasses TCP an other protocols as well.

When a server receives a request for an object to be delivered using RTP, the object typically is transcended from its native format to a packetizable format. A number of “Request for Comment” (RFC) message threads have been developed in the industry to resolve issues associated with packetizing data as described and are maintained for online access, for example, by the Internet Engineering Task Force (ietf.org), including an associated RFC for various given media types.

Each media object type is typically packetized somewhat differently, even with varying header formats among types, according to the standardized specification provided in the associated RFC. The differences are due to the different objects and issues encountered in handling data having different uses.

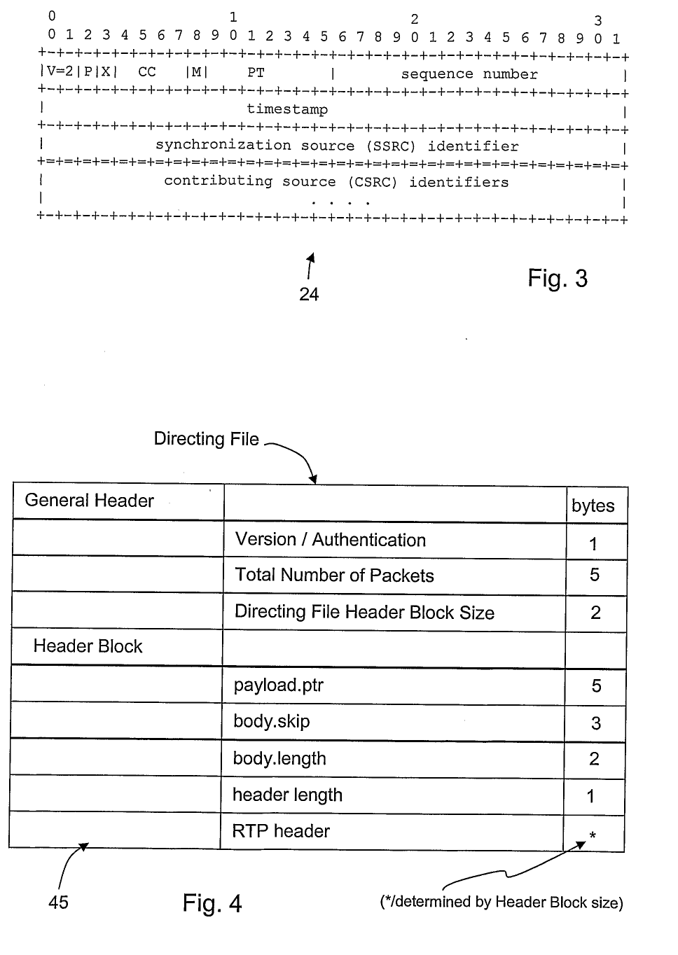

FIG. 3 shows the format of the common RTP header, for example as set forth in RFC 3550/3551. The header field abbreviations are as follows.

“V” represents the version number. The current version is version two. Although there is nothing inherent in the header that uniquely identifies the packet as being in RTP format, the appearance of the version number “2” at this header position is one indicator.

“P” is a value that indicates whether any padding exists at the end of the payload that should be ignored, and if so, the extent of padding. The last byte of the padding value gives the total number of padding bytes.

“X” is a value showing whether or not an extension header is present.

“CC” is a count of the number of contributing sources identified in this header.

“M” is a marker bit. The implementation of this bit is specific to the payload type.

“PT” identifies the payload type, namely the type of object being transported. Among other things, the payload type identifier allows the receiver to determine how to terminate the RTP stream.

“Sequence Number” is a count of the number of transferred RTP packets. It may be noted that this is unlike TCP, which uses a sequence number to indicate the number of transferred bytes. The RTP sequence number is the number of transferred RTP packets, i.e., a packet index.

“Timestamp” is a field value that depends on the payload type. Typically, the timestamp provides a time index for the packet being sent and in some instances provides a reference that allows the receiver to adapt to timing conditions in recording or playing back packet content.

“SSRC ID” identifies the source of the data being transferred.

“CSRC ID” identifies any contributing source or sources that have processed the data being transferred, such as mixers, translators, etc. There can be a plurality of contributing sources, or there may be none except the original source identified in SSRC ID. As noted above, the value CC in the header provides a count of contributing sources. The count allows the indefinite number of contributing source identifications to be treated as such, and to index forward to the content that follows the header.

If the X bit is set, there is an extension header that follows the RTP header. The use and nature of the extension header is payload-type-dependent. The payload-specific subheaders are generally specified in a way that allows packet loss to be ameliorated so as to be tolerable up to some frequency of occurrence. For some formats such as MPEG2, numerous complex subheaders with video and audio encoding information may follow the main RTP header.

The payload follows the last subheader in the packet shown in FIG. 3. The payload's relation to the native media object is also determined by the standard that describes the corresponding payload type. There is often not a one-to-one correspondence between the native object and the concatenation of RTP packet payloads. Although there are various factors that might contribute to this, some examples of situations underlying differences between the RTP packet payload sequences and the sequence of bytes contain in the native object might be due to:
a need to synchronize audio and video information for a given frame;
interleaving of data blocks within an RTP payload:
repeat packets for a crucial data element:
audio/video demuxing
or 1.1.3 RTCP

Periodically while a given RTP session is active, control information regarding the session is exchanged on a separate connection using RTCP (for UDP, the RTP session uses an even-numbered destination port and the RTCP information is transferred over the next higher odd-numbered destination port). RTCP performs various functions including providing feedback on the quality of the data distribution, which may be useful for a server to determine if network problems are local or global, especially in the case of IP multicast transfers. RTCP also functions to carry a persistent transport-level identifier for an RTP source, the CNAME. Since conflicts or program restarts may cause the migration of SSRC IDS, receivers require the CNAME to keep track of each participant. The CNAME may also be used to synchronize multiple related streams from various RTP sessions (e.g., to synchronize audio and video).

All participants in a transfer are required to send RTCP packets. The number of packets sent by each advantageously is scaled down when the number of participants in a session increases. By having each participant send its RTCP packets to all others, each participant can keep track of the number of participants. This number is in turn used to calculate the rate at which the control packets are sent. RTCP can be used to convey minimal session control information, such as participant information to be displayed in the user interface.

To accomplish these tasks, RTCP packets may fall into one of the following categories and formats:
SR:—sender report, for transmission and reception statistics from participants that are active senders;
RR:—receiver report, for reception statistics from participants that are not active senders and in combination with SR for active senders reporting on more than 31 sources;
SDES:—source description items, including CNAME;
BYE:—indicates end of participation; and,
PP:—application-specific functions.

Like RTP, each form of RTCP packet begins with a common header, followed by variable-length subheaders. Multiple packets can be concatenated to form a compound packet that may be sent together in a single packet of the lower-layer protocol. This produces a need for various counters and pointers to distinguish the position of expected fields in the stream.

It is an aspect of the present invention to optimize handling of streaming data in RTP format, in particular to facilitate egress streaming, by including with a streaming packet a directing file containing certain counting and index pointer values.

The egress streaming of RTP packets must be supported in real time. Real time handling is an important aspect of the RTP protocol that reduces the need for buffers (or at least their size) because the ongoing nature of the stream. The invention employs a variation of hinting that can directly provide the hardware with certain RTP packet information. Hinting in this way can accelerate RTP streaming on a server by removing the requirement that the server analyze the media being streamed on-the-fly.

“Hinting” is a term sometimes used to refer to information that is encoded together with compressed video such as MPEG-4, sent separately from the data to be compressed and used typically by a dedicated device capable of parsing the hint data to assist in decompressing associated compressed video data.

According to the present invention, a complementary information file is provided as a general header and header block. It is not necessary in this case for dedicated hardware to be able to parse the hint data so as to deal with a specific format of forward and backward-related image files. Instead, the directing file is a series of counting and pointing values used as indexes to locate RTP header and packet information.

The directing file differs from a decompression hinting mechanism or the like in that the pointer information is represented flexibly, i.e., can represent different packet data formats to allow for future expansion. Providing flexibility in a interfacing file could produce difficulties in moving part of the streaming functionality from a processor, which might be programmed to discern different formats, to a hardware element, where most parameters are fixed. The present method solves this problem by including all of the necessary information (except for the media object, itself) in a complementary directing file that can be used by the hardware, in part because the directing file contains indexing pointers as opposed to information that is formatted with known offsets and other expectations.

If a media file has a specified RTP packet type (normally documented by an RFC or thread of comments leading to stated refinements), and is accessible to the streamer, and is otherwise a candidate for streaming, a directing file is first generated by software running on the central processor (preferably running in the background, when resources are available).

This directing file is similar to hint data in that it tells the streamer how to packetize the object for RTP streaming, but it is much more specific about how to do so, and it assumes that the central processor has even less knowledge about the native media object. The format of an exemplary directing file 45 (a binary file) is shown in FIG. 4.

With reference to FIG. 4, The General Header is specified only at the beginning of the file and applies to the full block. The General Header comprises:
a version/authentication field that allows the streamer to verify that the directing file is of the correct format,
a Total Number of Packets field, which specifies the number of packets that will be transferred if the entire file is used,
a directing file Header Block Size, which specifies the number of bytes allocated for each header block in the directing file.

A Header Block is specified for each packet specified for transfer by directing file 45. The Header Block has a fixed length for a given directing file 45. The Header Block comprises:
payload.ptr, which is a filed containing the offset of the current packet payload from the beginning of the object in memory,
bodyskip: indicates how many bytes to skip (if any) from the current queue position until the beginning of the valid RTP payload,
body.length: indicates the length of the RTP payload
header.length: indicates the number of bytes of the RTP header field to use for the current RTP packet

When the directing file is generated, it is stored so that it can be associated with a particular object. As with hinting data, multiple directing files can be associated with an object if there are multiple ways the object could be streamed (different packet types, or different network attributes for the same packet type).

An extension of this fact allows the streamer to easily implement Trick-Play functionality by generating directing files that only point to I-frames, or only to every N I-frames, where N is related to the speed of fast forwarding specified by the directing file 45.

If a corresponding RTP session is not yet up and established, the apparatus remains poised until RTSP running on the core processor provides a SETUP command received from the endpoint. Once RTSP receives the SETUP message, it determines a set lookup parameters (source and destination IP addresses and ports, and transport protocol) from the SETUP message and allocates a connection table entry for that session in a content addressable memory CAM associated with the hardware accelerator. The valid bit is immediately set for the RTP session in the CAM. Then RTSP await a subsequent PLAY request from the associated control point. The PLAY message may contain a (time) range of the stream to play.

At this point the session can be considered established and the network accelerator and the traffic manager are ready to deliver data. The traffic manager has two associated queues available for each RTP session, an Object Queue, which is used for transferring data from the native media object, and a Header Queue, which is used for transferring the RTP headers that are read from the directing files. For each RTP packet to be sent, the traffic manager uses the fields of the directing file to extract the RTP header and payload, and schedules the resulting packet. The traffic manager then sends the packet to the network accelerator.

The network accelerator operations comprise the steps of:
adding an offset determined by the central processor and stored as a field in the CAM connection table entry for the associated transfer, to the Sequence Number field of the RTP header of the outgoing packet. This is advantageous to provide a random ISS, as specified in RFC 3550.
adjust the outgoing timestamp in a similar manner. This is advantageous to provide a random ITS, as specified in RFC 3550,
construct and apply (e.g., pre-pend) the layer three and layer four headers to the outgoing packet, and
send the outgoing packet to the MAC/PHY block.

This method allows the media object to be streamed without requiring the network accelerator to have any knowledge of the native media object format. Since the directing files are preferably generated by software running on the central processor, emerging packet types can be easily accommodated by software arrangements. This method further contributes to permitting the repetitive data pipeline functions of the streaming apparatus to be handed off from the control processor to the more hardware-oriented network accelerator. These repetitive data pipeline functions, which are not computationally complex, nevertheless are of high time priority. The invention optimally serves those functions in the network accelerator, and reserves the capacity and processing time of the central processor for control oriented less-frequent demands that benefit from computational complexity and are somewhat difficult to reconcile with the time demands of data pipeline functions of the streaming connection.

In keeping with the requirement that the network accelerator needs little or no knowledge of the media object format to handle the data packets using the directing file, it is preferred that the directing information be contained in a file rather than in a track. In this way, the server is not be required to know how to extract directing information for a particular outgoing packet or block of packets.

It is assumed that once the directing file 45 has been is generated, the object is available to be requested for streaming any number of times using the pointers and count values of the general header and block header as now set up. The streamer needs a way of accessing and sorting the directing information, which is convenient using files with pointers and counts as described. An added benefit is provided in that the egress streaming directing file 45 need not be transferred to the endpoint, which does not need the information used in connection with egress from the streaming apparatus that sends the packet or block of packets to the endpoint.

It is an aspect of the invention to improve the implementation of a total RTSP/RTP solution by providing a hybrid hardware and software solution instead of providing a hardware-only solution or a software-only solution. Any all-hardware solution would have to be quite complicated if it would provide for all control situation scenarios. By contrast, any software-only solution having a processor and coding capable of dealing such complication would not be fully exploited. For most operations after a given stream is in process, many of the operations for continuing to handle successive packets for a given stream in the same manner as previous packet are handled using operations that are repetitive and do not require the computational power.

The present invention is part of a hybrid solution wherein control processes are largely set up and arranged by a controller that can run a potentially complex and capable software program, but simply sets up the factors, values and pointers that will enable a network accelerator, preferably but not necessarily a hardware device, to continue while the connection is active to execute the streaming operation that the controller has set up.

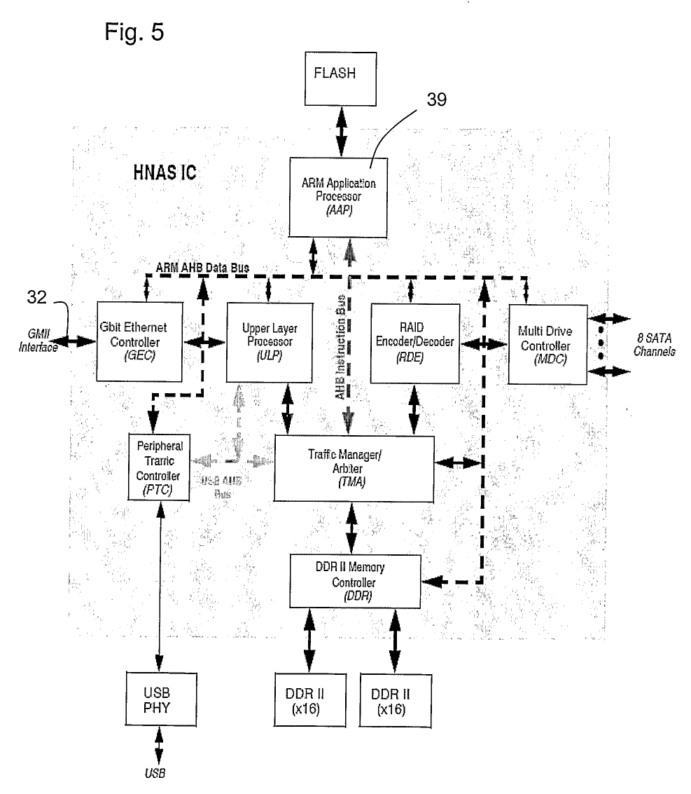

Referring to FIG. 5, in an advantageous embodiment, the invention is incorporated into a data manipulating system including a disk array controller device. This device can performs storage management and serving for consumer electronics digital media applications, or other applications with similar characteristics, such as communications and teleconferencing. In an entertainment application, the device provides an interface between a home network and an array of data storage devices, generally exemplified by hard disk drives (HDDs) for storing digital media (audio, video, images).

The device preferably provides an integrated 10/100/1000 Ethernet MAC port for interfacing toward a home network or other local area network (LAN). A USB 2.0 peripheral attachment port is advantageously provided for connectivity of media input devices (such as flash cards) or connectivity to a wireless home network through the addition of an external wireless LAN adapter.

The preferred data manipulating system employs a number of layers and functions for high-performance shared access to the media archive, through an upper layer protocol acceleration engine (for IP/TCP, IP/UDP processing) and a session-aware traffic manager. The session aware traffic manager operates as the central processor that in addition to managing RTP streaming as discussed herein, enables allocation of shared resources such as network bandwidth, memory bandwidth, and disk-array bandwidth according to the type of active media session. For example, a video session receives more resources than an image browsing session. Moreover, the bandwidth is allocated as guaranteed bandwidth for time-sensitive media sessions or as best-effort bandwidth for non time sensitive applications, such as media archive bulk upload or multi-PC backup applications.

The data manipulating system includes high-performance streaming with an associated redundant array of independent disks (RAID). The streaming-RAID block can be arranged for error-protective redundancy and protects the media stored on the archive against the failure of any single HDD. The HDDs can be serial ATA (SATA) disks, with the system, for example including eight SATA disks and a capacity to handle up to 64 simultaneous bidirectional streams through a traffic manager/arbiter block.

Inasmuch as the data manipulating systems is an example of various possible applications for the invention, the overall data manipulating system is shown in FIG. 7 and described only generally. There are two separate data paths within the device, namely the receive path and the transmit path. The “receive” path is considered the direction by which traffic flows from other external devices to the system, and the “transmit” path is the opposite direction of data flow, which paths lead at some point from a source and toward a destination, respectively, in the context of a given stream.

The Upper Layer Processor (ULP) is coupled in data communication to/from either a Gigabit Ethernet Controller (GEC) or the Peripheral Traffic Controller (PTC). The PTC interfaces directly to the Traffic Manager/Arbiter (TMA) for non packet based transfers. Packet transfers are handled as discussed herein.

In the receive data path, either the GEC or PTC block typically receives Ethernet packets from a physical interface, e.g., a to/from a larger network. The GEC performs various Ethernet protocol related checking, including packet integrity, multicast address filtering etc. The packets are passed to the ULP block for further processing.

The ULP parses the Layer 2, 3 and 4 header fields that are extracted to form an address. A connection lookup is then performed based on the address. Using the lookup result the ULP makes a decision as to where to send the received packet. An arrival packet from an already established connection is tagged with a pre-defined Queue ID (QID) for traffic queuing purpose used by TMA. A packet from an unknown connection requires further investigation by and application processor (AAP). The packet is tagged with a special QID and routed to AAP. The final destination of an arrival packet after AAP will be either the hard disks for storage when it carries media content or the AAP for further investigation when it carries a control message or the packet can not be recognized by AAP, potentially leading to the establishment of a new Queue ID. In any of the above conditions, the packet is sent to TMA block.

TMA stores the arriving traffic in the shared memory. In the case of media object transfers, the incoming object data is stored in memory, and transferred to a RAID Decoder and Encoder (RDE) block for disk storage. TMA manages the storage process by providing the appropriate control information to the RDE. The control traffic destined for AAP inspection are stored in the shared memory as well, and the AAP is given access to read the packets in memory. The AAP also uses this mechanism to re-order any of the packets received in out-of-order. A part of the shared memory and disk contains program instructions and data for the AAP. The TMA manages the access to the memory and disk by transferring control information from the disk to memory and memory to disk. The TMA also enables the AAP to insert data and extract data to and from an existing packet stream.

In the transmit data path, TMA manages the object retrieval requests from the disk that are destined to be processed as necessary to send via the Application Processor or the network interface. Upon receiving a media playback request from the Application Processor, the TMA receives the data transferred from the disks through MDC and RDE blocks and stores it in memory. The TMA then schedules the data to ULP block according to required bandwidth and media type. The ULP encapsulates the data with the Ethernet and L3/L4 headers for each outgoing packet. The packets are then sent to either GEC or PTC block based on the destination port specified.

For incoming packets on the receive data path, a connection lookup functional part of the network accelerator can include address forming, CAM table lookup, and connection table lookup functional blocks. The CAM lookup address is formed in part as a result of information extracted from the incoming packet header. The particulars of the header field to be extracted depend on the traffic protocol in use. The to-be-formed address has to represent a unique connection. For most popular internet traffic, for example carried in IP V4 and TCP/UDP protocol, the source IP address, destination IP address, TCP/UDP source port number, TCP/UDP destination port number and protocol type (the so called “five tuple” from packet header) define a unique connection. Other fields may be used to determine a connection if a packet is of different traffic protocol (such as IP V6). Appropriate controls such as flags and identifying codes can be referenced where multiple protocols are served, so as to make the system a “protocol aware” hierarchical one. For example, the process can be divided into three stages, with each stage corresponding to a level of protocol supported. A first stage can check the version number of L3 protocol from a field extracted during the header parsing process and stored in an information buffer entry for an arriving packet as a step in the address forming process. For second and third stages in the address forming process, a composite hardware table is provided. The table entry number at each stage depends on the stage the table is in and the number of different protocols to be supported at each stage. Each table entry always consists of a content addressable memory (CAM) entry and a position number register. Each position register is always composed of a pair of offset-size fields. Each CAM entry stores the specific protocol values for the corresponding position register. The offset specifies the number of bytes to be skipped from the beginning of packet header to the field to be extracted. The size field specifies the number of nibbles to be extracted. The same address is used to access both the CAM field and the position register.

For outgoing packet egress, the invention employs directing files as described, which can be established in memory accessible to the central processor at any point in the configuration.

The invention has been disclosed in connection with a exemplary embodiments but reference should be made to the appended claims rather than the discussion of examples to determine the scope of the invention in which exclusive rights are claimed.

What is claimed is:

1. A streaming apparatus for directing data packets from at least one source of data packets to at least one destination for the data packets, comprising:
a network accelerator in data communication with the source of data packets and with the destination;
a control processor operable to control streaming of the data packets from the source to the destination;
wherein the control processor is programmed to establish a set of parameter values that are communicated from the control processor to the network accelerator at least during a predetermined step in streaming of the data packets from the source to the destination; and,
wherein the network accelerator is configured to stream the data packets from the source to the destination subsequent to the predetermined step, as a function of the parameter values and substantially independently of the control processor.

2. The streaming apparatus of claim 1, wherein at least one of the source and the destination comprises a client in communication with the control processor over a data communication network to which the source and the network accelerator are coupled.

3. The streaming apparatus of claim 1, wherein the parameter values established by the control processor include addressing information identifying at least two clients in data communication with the control processor and the network accelerator over a communication network.

4. The streaming apparatus of claim 3, wherein the parameter values are established by the control processor as a function of a request signal initiated by one of the source and the destination including at least addressing information for the source and the destination.

5. The streaming apparatus of claim 3, wherein the parameter values are provided in a directing file populated by the control processor and further comprising a memory coupled to the processor containing a plurality of directing files respecting plural concurrent streaming operations.

6. The streaming apparatus of claim 4, wherein the parameter values comprise an identifying code, a packet count, a header block size and one of a position pointer and count value.

7. The streaming apparatus of claim 3, wherein the parameter values are established by the control processor as a function of a request signal and are transmitted from the control processor to the network accelerator as a generalized header containing an identifying code for the data packets.

8. The streaming apparatus of claim 7, wherein the network accelerator is operable to include the generalized header with packets transmitted to the destination.

9. The streaming apparatus of claim 8, wherein the network accelerator is operable to insert control information into the generalized header transmitted to the destination as streaming of the packets proceeds.

10. The streaming apparatus of claim 9, wherein the network accelerator is operable to insert packet data counts by which the destination can order received packets.

11. The streaming apparatus of claim 1, wherein:
the control processor, at least one of the source and the destination, and the network accelerator, communicate presentation control messages, individual session control messages and real time streaming packets, and the control processor processes the control messages whereas the network accelerator processes the real time streaming packets.

12. The streaming apparatus of claim 11, wherein the control processor controls streaming by the network accelerator by establishing steps including:
SETUP wherein communication resources are allocated for a streaming operation;
at least one of PLAY and RECORD to commence a streaming operation in at least one direction between at least one said source and at least one said destination; and,
at least one of PAUSE and TEARDOWN, wherein a previously commenced streaming operation is suspended, respectively while preserving allocation of said resources for PAUSE and relinquishing said resources for TEARDOWN.

13. The streaming apparatus of claim 12, wherein the control processor is operable according to RTSP protocol for said presentation control messages, RTCP protocol for said individual session control messages and wherein the real time streaming packets comply with RTP protocol using at least one of TCP and UDP protocol.

14. A method for streaming content substantially in real time, comprising:
providing packetized data content with associated header information by which the packetized data content is processed at least at one of a source and a destination for the content;
initiating a streaming operation, addressing at least one of a source and a destination for the streaming operation, and effecting at least one of pause and a stop of the streaming operation, as a function of programmed operations of a control processor that is in data communication with at least one of the source and the destination;
wherein the control processor is operable according to said programmed operation to establish a directing file containing information that is at least temporarily maintained during progress of the streaming operation; and,
after initiation of the streaming operation, carrying on the streaming operation information by operation of a network accelerator that processes information provided from the directing file and processed as the streaming operation proceeds.

15. The method of claim 14, wherein the network accelerator inserts information from the directing file into packet headers transmitted during the streaming operation.

16. The method of claim 15, wherein the network accelerator inserts into the packet headers addressing information and at least one of packet data counts and packet data pointers.

17. The method of claim 16, further comprising altering the streaming operation by programmed operation of the control processor after said initiation of the streaming operation.

18. The method of claim 14, further comprising establishing and maintaining via the control processor a plurality of directing files, each of the directing files respecting at least one concurrently operating streaming operation.
